(19) United States
(12) Patent Application Publication
(10) Pub. No.: US 2011/0264755 A1
(43) Pub. Date: Oct. 27, 2011

(54) SYSTEM AND METHOD FOR THE AUTOMATED CUSTOMIZATION OF AUDIO AND VIDEO MEDIA

(76) Inventor: Jéremie Salvatore De Villiers, Saint-Hubert, (CA)

(21) Appl. No.: 13/123,288

(22) PCT Filed: Oct. 8, 2009
(86) PCT No.: PCT/CA2009/001434

§ 371 Date: Jul. 7, 2011

Related U.S. Application Data
(60) Provisional application No. 61/136,840, filed on Oct. 8, 2008.

(51) Int. Cl. G06F 15/16

(52) U.S. Cl. 709/206

(57) ABSTRACT

A system and method for customizing a communication media in the form of audio and/or video media, the method comprising providing the communication media with a pre-treated segment for receiving a message, acquiring the message, inserting the message within the pre-treated segment of the communication media and creating a customized communication media by mixing the message and communication media.

### TECHNICAL FIELD

The present invention relates to a system and method for the automated customization of audio and video media. More specifically, the present invention relates to a method and system for the integration of audio messages into audio or video media and/or the integration of audio/video or video messages into video media.

### BACKGROUND

Songs and music video clip revenues have been declining due to piracy. These revenues are still considered to be acceptable yet they do not represent the full revenue potential. Music labels have been confronted by the question: “Why pay for something when you can get it for free?”

Thus, there is a need for a solution to this downward spiral in the form of a service providing a novel use of digital media (i.e. songs and music clips) that can be used many times a year by the same person; one that generates revenues at every use, and a service that still manages to protect copyrights.

### SUMMARY

In accordance with the present invention, there is provided a method for customizing a communication media, the method comprising:
a. providing the communication media with a pre-treated segment for receiving a message;
b. acquiring the message;
c. inserting the message within the pre-treated segment of the communication media; and
d. creating a customized communication media by mixing the message and communication media.

In accordance with the present invention, there is also provided a system for customizing a communication media, the system comprising:
a database containing at least one communication media with a pre-treated segment for receiving a message;
a user interface;
a recording interface;
a processor operatively connected to the database, the user interface and the recording interface, the processor being so configured so as to:
   display through the user interface a list of the communication media in the database;
   prompt a user through the user interface to select a listed communication media;
   prompt the user to provide a message through the recording interface;
   insert the message within the pre-treated segment of the selected communication media; and
   create a customized communication media by mixing the message and the selected communication media.

### BRIEF DESCRIPTION OF THE FIGURES

Embodiments of the invention will be described by way of example only with reference to the accompanying drawings, in which:

FIG. 1 is a schematic view of computing devices connected to an audio/video customization system through a network;

FIGS. 2A and 2B are a flow diagram of an illustrative example of the audio/video media customization process;

FIGS. 3A and 3B are a flow diagram of an illustrative example of the mixing process for audio media; and

FIG. 4 is a flow diagram of an illustrative example of the mixing process for video media.

### DEFINITIONS

The detailed description and figures refer to the following terms which are herein defined:
Audio media: includes audio recordings, musical compositions, songs, speeches, spoken words, poems, etc.
Video media: includes music video clips, movies, movie extracts, short films, video commercials, etc. It may have only video content or a combination of audio and video content.
Audio/video media: includes audio only media, video only media or combined audio and video media.
Audio/video message: includes audio only messages, video only messages or combined audio and video messages.

### DETAILED DESCRIPTION

Generally stated, the non-limitative illustrative embodiment of the present invention provides a system and method for the automated customization of communication media such as audio and/or video media. More specifically, the system and method allow the integration of audio messages into audio or video media and/or the integration of audio/video messages into video media. For example, the automated customization system and method allow users to send a vocal message over a musical backdrop of songs by many of their favorite artists. The user records a message; the message is seamlessly inserted within an instrumental portion of the chosen song and is followed perfectly by the hook of the song. The user can then send the customized message to any internet-based device (smart phones, desktops, laptops, Facebook™, MySpace™, IPhone™ Blackberry™, Android phones, etc.)

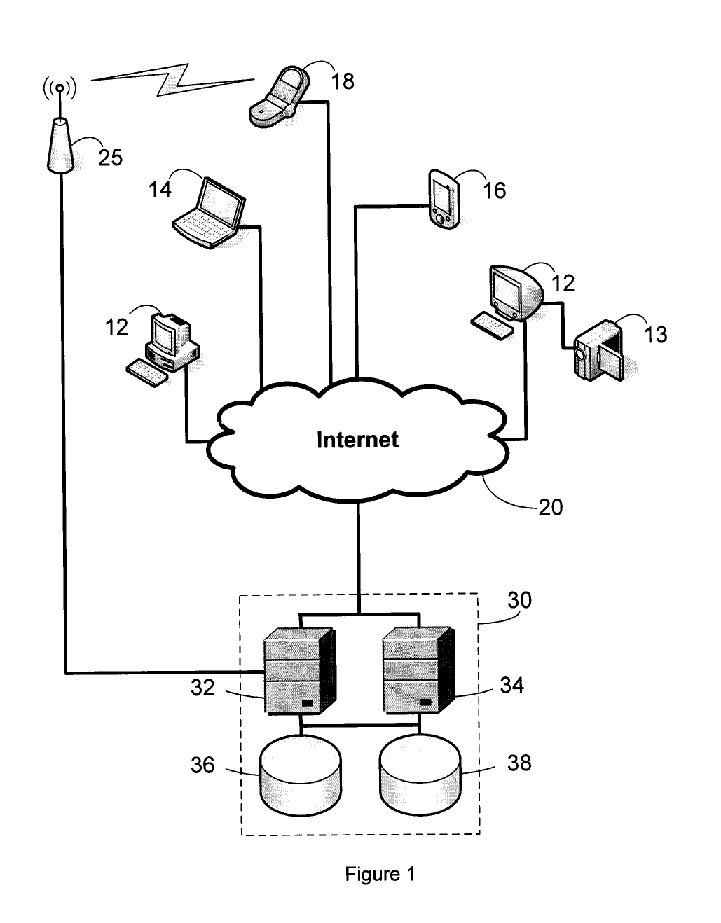

Referring to FIG. 1, a user using a personal computer 12, laptop computer 14, personal assistant device 16, mobile phone or smart phone 18, or any other such device on which may run a user interface in the form of a communication software such as, for example, a web browser, may access a web interface on the web server 32 of the audio/video customization system 30 via an Internet connection 20 such as, for example, Ethernet (broadband, high-speed), wireless WiFi, cable Internet, satellite connection, cellular or satellite network, etc.

It is to be further understood that when the audio/video customization system 30 is used in conjunction with mobile phones and smart phones 18 (including Blackberry™, SymbianOST™, iPhone™, Windows Mobile™, Google Android™ and any other such system/device), the web server 32 may also include a specifically created graphical user interface.

Further to the web server 32, the audio/video customization system 30 includes a customization server 34, a media database 36 and a customized media database 38, all of which will be detailed further below. It is to be understood, however, that although throughout the disclosure reference is made to separate servers 32 and 34 as well as separate databases 36 and 38, these may be implemented on one or more physical device and/or may be combined and/or may be implemented by a data structure within a computer memory.

In an alternative embodiment, the audio/video customization system 30 may be implemented as an application for a smart phone 18 such as, for example, an iPhone™. In this embodiment, a smart phone application replaces the web server 32. As for the customization server 34, media database 36 and customized media database 38, these may be implemented in the application itself, the media database 36 and customized media database 38 being implemented as data structures within the memory of the smart phone 18 or remotely accessed by the application. Accordingly, it is to be understood that from hereon any reference to the audio/video customization system 30 applies equally to both the case where it is implemented as a web site and to the case where it is implemented as a smart phone application.

### Audio/Video Media Customization

The audio/video customization system 30 enables the integration of user-generated audio/video messages into selected audio/video media. The customization involves the insertion of the user-generated audio/video messages within one or more segments of pre-treated audio/video media, mixing the resulting customized audio/video media and presenting it as a new audio/video file in the form of, for example, an MP3 (or any other type of compressed audio file) or an MPEG (of any type of compressed video file).

For the purpose of the following description the audio/video media will be assumed to be either a song (for audio media) or a music video clip (for video media), but it is to be understood that other types of audio or video media may be used as well.

Referring back to FIG. 1, the pre-treated songs/music video clips, which consist in new or pre-existing songs/music video clips in which one or more segments have been identified and modified in order to make space for the insertion of future audio/video messages, are stored in the media database 36. The modified segments are then used by the customization server 34 to allow an administrator of the audio/video customization system 30 to pre-program the positioning and length of each segment allotted for user-generated audio/video messages. Each song/music video clip is typically pre-programmed to receive either one, two or three user-generated audio/video messages depending on the musical make-up of the song/music video clip. However, it is to be understood that some songs/music video clips may be pre-programmed to receive more than three audio/video messages.

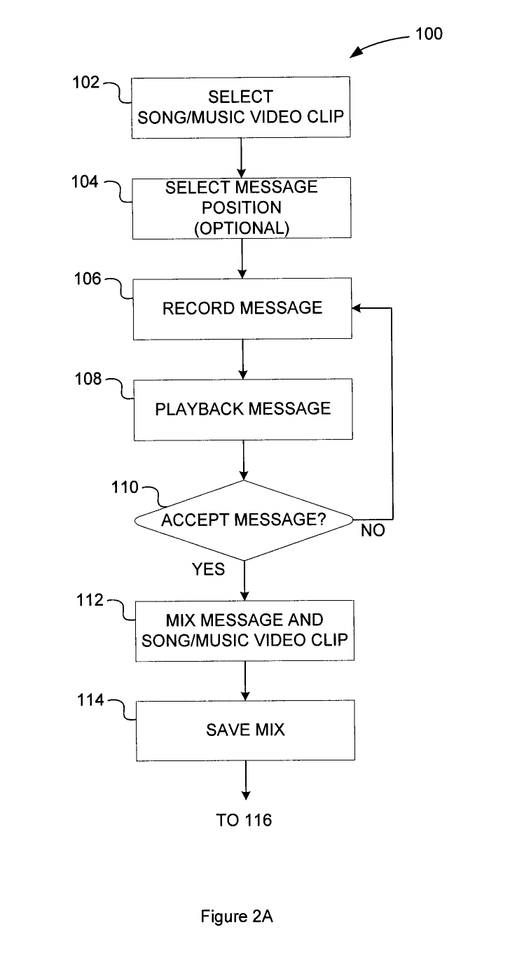

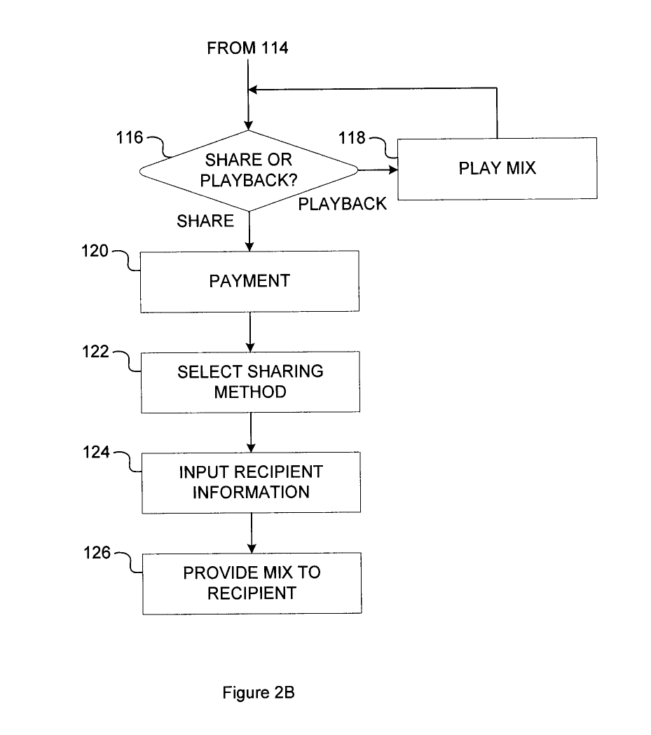

Referring now to FIGS. 2A and 2B, there is shown a flow diagram of an illustrative example of the audio/video media customization process 100 executed by the audio/video customization system 30. The steps of the process 100 are indicated by blocks 102 to 126.

The process 100 starts at block 102 where a user accesses the web interface on the web server 32 of the audio/video customization system 30, or starts the corresponding audio/video customization application on its smart phone 18, and selects a song/music video clip from the media database 36 he or she wishes to customize. It is to be understood that the web interface or smart phone application may offer search capabilities, display songs/music video clips by categories, artist names, song/music video clip titles, etc.

Then, at block 104, the user selects the number of audio/video messages to be inserted within the song, for example one, two or three. It is to be understood that the number of available segments for the insertion of audio/video messages may vary depending on the selected song/music video clip or settings of the audio/video customization system 30. For the purpose of the following description, in order to lighten the text, it will be assumed that the user as selected to insert one audio/video message within the song/music video clip. It is to be understood that this step may be optional and that the audio/video customization system 30 may provide for only one audio/video message to be inserted within the song/music video clip. In such a case, block 104 would be omitted.

At block 106, the process 100 provides a recording interface so that the user may record its audio/video message. The recording interface may take various forms depending on, for example, whether the audio/video message is an audio only message or the audio/video customization system 30 is implemented as a smart phone application, etc. The process 100 may provide a given recording interface or may optionally offer a selection of recording interfaces and prompt the user to select one.

Examples of recording interfaces include:
a telephone recording interface (for audio messages only), for which the user is provided with a phone number to dial along with an associated pin. The user is then able to record the audio message through his or her land phone, mobile phone or smart phone 18 (used as a microphone only in this case), through a regular telecommunication network 25 (land line, cellular network, etc.) or IP telephony. The time allotted depends on the chosen song/music video clip and the number of messages to be inserted within the song/music video clip, an audible beep may serve as a warning of the end of the allotted time, for example five seconds before the end;
a web recording interface, for which the user is directed to a web page on the web server 32, which includes, for example, a Java audio/video engine. The web recording interface may include the verification of the user's computer 12, 14 microphone levels and/or video camera 13 picture quality in order to prevent distortion in the recording and/or picture quality. The time allotted depends on the chosen song/music video clip and the number of messages to be inserted within the song/music video clip, an on-screen time bar may give a visual indication of the remaining allotted time; or
a smart phone application recording interface that uses the smart phone 18 microphone and camera to record the audio/video message.

In an alternative embodiment, the user may be given the option of providing the audio/video message as an MP3 or MPEG (or any other type of compressed audio or video file), through email or, in a further alternative embodiment, by mail on a CD/DVD or other digital medium.

At block 108, the user can playback the recorded audio/video message and, at block 110, accept or refuse the recorded audio/video message. If the user refuses the recorded audio/video message, the process 100 returns to block 106 where a new audio/video message is recorded. If the recorded audio/video message is accepted, the process 100 proceeds to block 112 where the recorded audio/video message is mixed with the chosen song/music video clip. The mixing process, which is executed by a processor of the customization server 34, will be further detailed below.

Once the recorded audio/video message and the chosen song/music video clip have been mixed, the mixed song/music video clip (i.e. customized song/music video clip) is saved, at block 114, in the customized media database 38.

At block 116, the process 100 queries the user as to whether he or she wishes to play back the customized song/music video clip or share it. If the user opts to play back the customized song/music video clip, the process 100 proceeds to block 118 where the customized song/music video clip is played back to the user, after which it proceeds back to block 116. If the user opts to share the customized song/music video clip, the process 100 proceeds to block 120.

At block 120, the user is asked to input his or her payment information. This may be through a credit card, Paypal™, In app purchase (in the case of a smart phone such as, for example, an iPhone™) or any other suitable payment method. This step may also include the verification of the payment before proceeding any further.

At block 122, the process 100 prompts the user to select the desired sharing method. The proposed sharing methods may include, for example, email, on a CD/DVD through regular mail, as a link to the customized song/music video clip in the customized media database 38, iPhone Push (in the case where the audio/video customization system 30 is implemented as an iPhone™ application) or any other applicable transmission means.

Then, at block 124, the user inputs information related to the intended recipient the customized song/music video clip. This information may be, for example, an email address, phone number, physical location address, etc., and may also include, optionally, a text message addressed to the intended recipient.

Finally, at block 126, depending on the sharing method selected at block 122 and the intended recipient information entered at block 124, the customized song/music video clip is provided to the intended recipient, through the selected sharing means.

It is to be understood that the order in which the various steps are executed may vary. It is also to be understood that some of the steps may be omitted or that additional ones may be added.

### Mixing Process

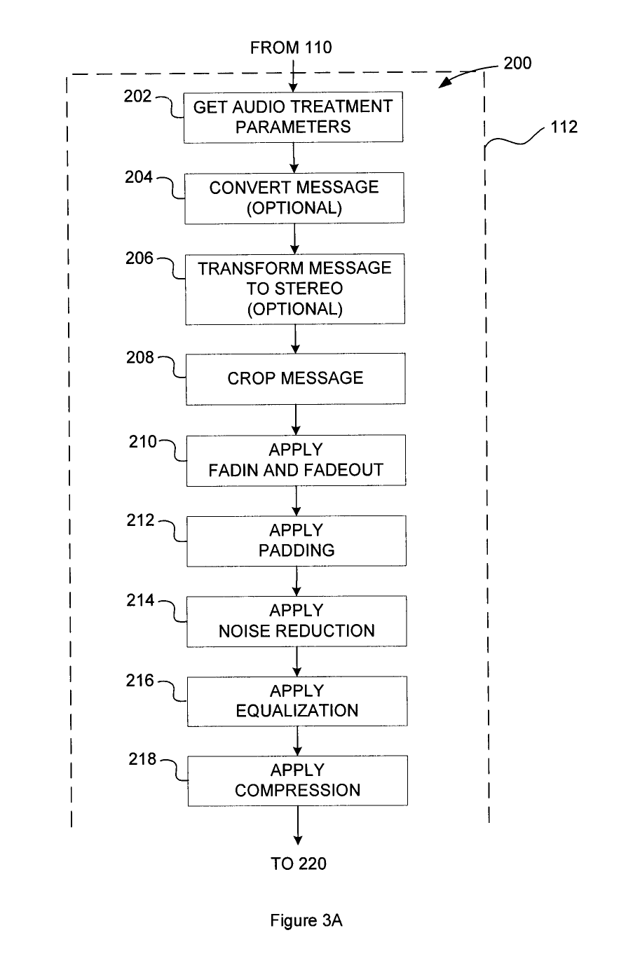

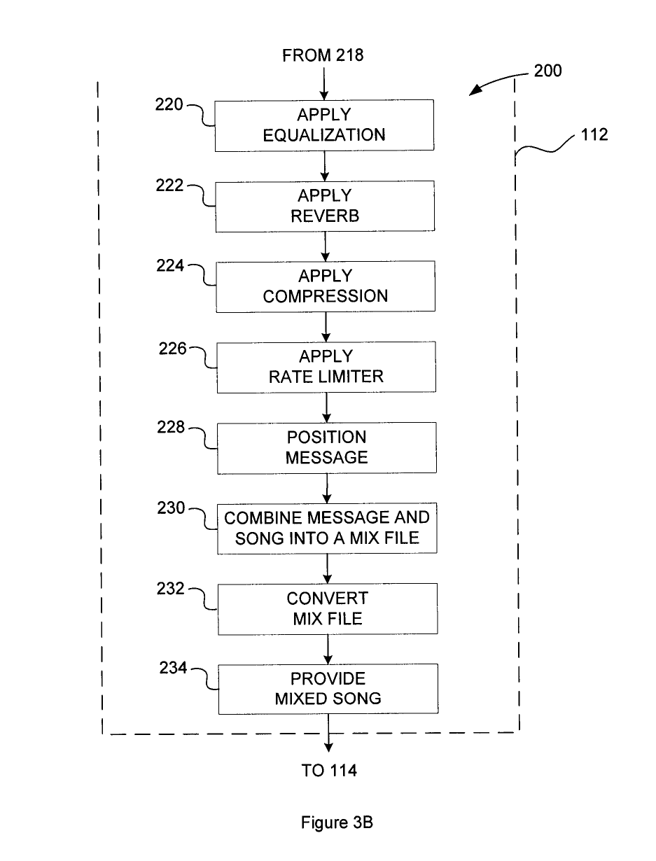

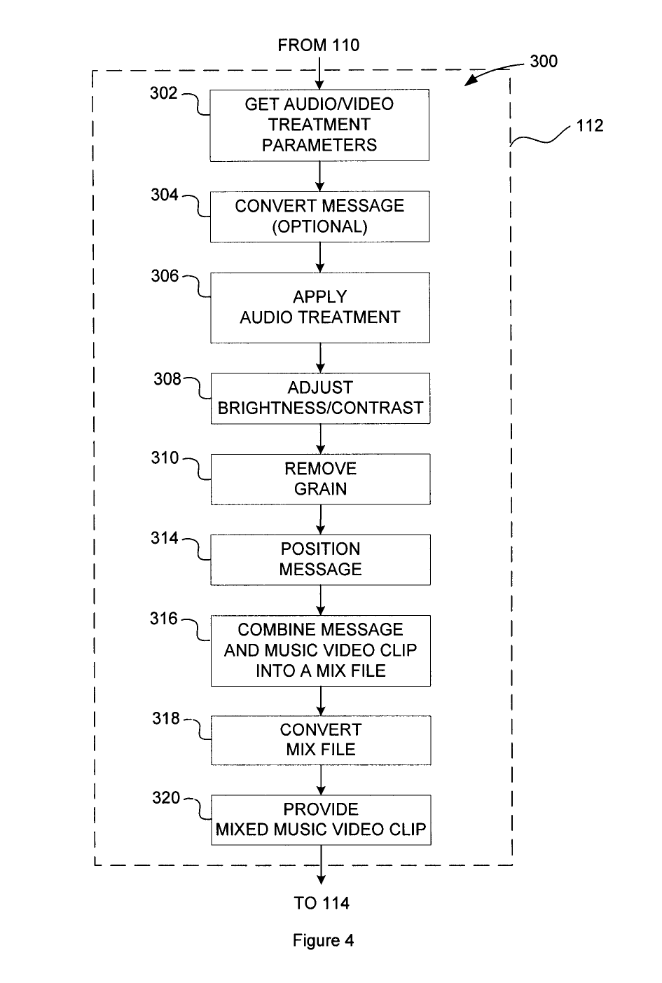

As defined in the present disclosure, the audio/video media covers both audio media and video media. Accordingly, FIGS. 3A and 3B show an illustrative example of the mixing process for audio media while FIG. 4 shows an illustrative example of the mixing process for video media.

### Audio Media Mixing Process

Referring to FIGS. 3A and 3B, there is shown a flow diagram of an illustrative example of the mixing process 200 executed by a processor of the customization server 34 at block 112 of the audio/video media customization process 100 (see FIGS. 2A and 2B) when the audio/video media is an audio media. The steps of the process 200 are indicated by blocks 202 to 234.

The audio mixing process 200 automatically processes the recorded audio message through audio digital signal processing (DSP) effects so that the recorded audio message sounds like it was recorded in a recording studio prior to being integrated into the song. This gives the final product, i.e. the customized song, a “professionally produced” sound.

The process 200 starts at block 202, where it loads the audio treatment parameters associated with the selected music video clip. These audio treatment parameters are used for the various DSP effects applied to the recorded video message. In an alternative embodiment, the audio treatment parameters may be further associated with the device or method being used to record the audio message.

At block 204, the recorded audio message may optionally be converted into a format more suitable for the mixing process, for example into the WAV format.

At block 206, the recorded audio message may then optionally be transformed into stereo. This step applies when the audio message has been recorded in mono such as, for example, when recorded from a smart phone 18 microphone.

Then, at block 208, the recorded audio message is cropped so as to remove silences at its beginning and ending.

Following this, at block 210, fading such as very fast fades is applied at the beginning and the ending of the recorded audio message in order to prevent pops and clicks.

At block 212, padding is added at the end of the recorded audio message so that it doesn't stop too abruptly and, at block 214, noise reduction is applied to reduce background noise.

At block 216, the recorded audio message is equalized and then, at block 218, compressed in order to regulate its volume.

Then, at block 220, the recorded audio message is once more equalized (the parameters of which may vary from the first equalization) and, at block 222, reverb is applied to add different ambiences.

At block 224, the recorded audio message is then compressed once more (the parameters of which may vary from the first compression) after which, at block 226, a rate limiter is applied to limit distortion.

Following the DSP effects, at block 228, the processed audio message is inserted into the pre-determined segment of the pre-treated song. The processed audio message is strategically placed in the allotted time segment depending on the length of the message. If the user has not used up all of the time available for his or her message, the process 200 automatically places the processed audio message at the end of the time allotted segment in order to maximize the “professionally produced” effect.

Once the processed audio message is integrated into the pre-treated song, audio encoding compression is applied, at block 232, to optimize portability, for example into an MP3 file, which is then, at block 234, provided to block 114 of process 100 (see FIGS. 2A and 2B).

### Video Media Mixing Process

Referring to FIG. 4, there is shown a flow diagram of an illustrative example of the mixing process 300 executed by a processor of the customization server 34 at block 112 of the audio/video media customization process 100 (see FIGS. 2A and 2B) when the audio/video media is a video media. The steps of the process 400 are indicated by blocks 302 to 320.

The video mixing process 300 automatically processes the audio portion of the recorded video message through DSP effects and the video portion through digital video filters in order to obtain optimal sound and video quality prior to being integrated into the music video clip. This gives the final product, i.e. the customized music video clip, a “professionally produced” sound and look.

The process 300 starts at block 302, where it loads the video treatment parameters associated with the selected music video clip. These video treatment parameters are used for the various DSP effects and digital video filters applied to the recorded video message. In an alternative embodiment, the video treatment parameters may be further associated with the device or method being used to record the video message.

At block 304, the recorded video message may optionally be converted into a format more suitable for the mixing process.

Then, at block 306, the audio portion of the video message is treated by applying DSP effects similar to those of process 200 of FIGS. 3A and 3B.

At block 308, the brightness and contrast of the video portion of the recorded video message are adjusted and, at block 310, grain reduction is applied.

Following the DSP effects and digital video filters, at block 314, the processed video message is inserted into the pre-determined segment of the pre-treated music video clip. The processed video message is strategically placed in the allotted time segment depending on the length of the message. If the user has not used up all of the time available for his or her message, the process 300 automatically places the processed audio/video message at the end of the time allotted segment in order to maximize the “professionally produced” effect.

Once the processed video message is integrated into the pre-treated music video clip, the end of the video portion of the video message is automatically dissolved back to the music video clip. Video encoding compression is then applied, at block 318, to optimize portability, after which, at block 320, the customized music video clip is provided to block 114 of process 100 (see FIGS. 2A and 2B).

It is to be understood that the order in which the various DSP effects and digital video filters are applied, and the number of times they are applied, may vary. It is also to be understood that some of the DSP effects and/or digital video filters may be omitted or that additional ones may be added. The DSP effects and/or digital video filters may also vary depending on the selected song/music video clip. For example, in the case of song that includes a choir, the reverb DSP effect at block 222 of process 200 (see FIG. 3B) may be applied a plurality of times.

Although the present invention has been described by way of particular embodiments and examples thereof, it should be noted that it will be apparent to persons skilled in the art that modifications may be applied to the present particular embodiment without departing from the scope of the present invention.

What is claimed is:

1. A method for customizing a communication media, the method comprising:
a. providing the communication media with a pre-treated segment for receiving a message;
b. acquiring the message;
c. inserting the message within the pre-treated segment of the communication media; and
d. creating a customized communication media by mixing the message and communication media.

2. A method in accordance with claim 1, further comprising:
e. storing the customized communication media in a database.

3. A method in accordance with claim 1, wherein step a. includes the sub-steps of:
a1. displaying a list of available communication media with a pre-treated segment for receiving a message;
a2. prompting a user to select a listed communication media;
a3. providing the selected communication media.

4. A method in accordance with claim 1, wherein step b. includes the sub-steps of:
b1. prompting a user to provide a message; and
b2. acquiring the message from the user.

5. A method in accordance with claim 1, wherein step b. includes the sub-steps of:
b1. prompting a user to provide a message;
b2. providing the user with a message recording interface; and
b3. acquiring the message.

6. A method in accordance with claim 1, further comprising:
e. prompting a user to input information related to an intended recipient; and
f. proving the customized media to the intended recipient.

7. A method in accordance with claim 1, further comprising:
e. prompting a user to input payment information.

8. A method in accordance with claim 1, wherein the communication media includes a plurality of pre-treated segments and wherein a plurality of messages are acquired, each message corresponding to an associated pre-treated segment.

9. A method in accordance with claim 1, wherein the communication media is one of an audio media and a video media.

10. A method in accordance with claim 1, wherein the communication media is an audio media and the message is an audio message, the method further comprising the step of applying digital signal processing effects to the message before inserting the message into the pre-treated segment of the communication media.

11. A method in accordance with claim 10, wherein audio treatment parameters of the digital signal processing effects are selected in accordance with the communication media.

12. A method in accordance with claim 10, wherein audio treatment parameters of the digital signal processing effects are selected in accordance with the means of acquiring the message.

13. A method in accordance with claim 1, wherein the communication media is a video media and the message is a video message, the method further comprising the step of applying digital video filters to the message before inserting the message into the pre-treated segment of the communication media.

14. A method in accordance with claim 13, wherein video treatment parameters of the digital video filters are selected in accordance with the communication media.

15. A method in accordance with claim 13, wherein video treatment parameters of the digital video filters are selected in accordance with the means of acquiring the message.

16. A method in accordance with claim 1, wherein the communication media is an audio and video media and the message is an audio and video message, the method further comprising the step of applying digital signal processing effects to an audio portion of the message and applying digital video filters to a video portion of the message before inserting the message into the pre-treated segment of the communication media.

17. A method in accordance with claim 16, wherein audio treatment parameters of the digital signal processing effects and video treatment parameters of the digital video filters are selected in accordance with the communication media.

18. A method in accordance with claim 16, wherein audio treatment parameters of the digital signal processing effects and video treatment parameters of the digital video filters are selected in accordance with the means of acquiring the message.

19. A system for customizing a communication media, the system comprising:
a database containing at least one communication media with a pre-treated segment for receiving a message;
a user interface;
a recording interface;
a processor operatively connected to the database, the user interface and the recording interface, the processor being so configured so as to:
display through the user interface a list of the communication media in the database;
prompt a user through the user interface to select a listed communication media;
prompt the user to provide a message through the recording interface;
insert the message within the pre-treated segment of the selected communication media; and
create a customized communication media by mixing the message and the selected communication media.

20. A system in accordance with claim 19, wherein the communication media is an audio media and the message is an audio message, the processor being further configured so as to apply digital signal processing effects to the message before inserting the message into the pre-treated segment of the communication media.

21. A system in accordance with claim 20, wherein audio treatment parameters of the digital signal processing effects are selected in accordance with the selected communication media.

22. A system in accordance with claim 19, wherein the communication media is a video media and the message is a video message, the processor being further configured so as to apply digital video filters to the message before inserting the message into the pre-treated segment of the communication media.

23. A system in accordance with claim 22, wherein video treatment parameters of the digital video filters are selected in accordance with the selected communication media.

24. A system in accordance with claim 19, wherein the communication media is an audio and video media and the message is an audio and video message, the processor being further configured so as to apply digital signal processing effects to an audio portion of the message and applying digital video filters to a video portion of the message before inserting the message into the pre-treated segment of the communication media.

25. A system in accordance with claim 24, wherein audio treatment parameters of the digital signal processing effects and video treatment parameters of the digital video filters are selected in accordance with the selected communication media.
